(19) United States
(12) Patent Application Publication
(10) Pub. No.: US 2026/0272227 A1
(43) Pub. Date: Sep. 17, 2026

(54) MICRO PUREE MACHINE

(71) Applicant: Guangdong Link Plus Technology Group Co., Ltd, Foshan (CN)

(72) Inventors: Long LI, Foshan (CN); Chunlong LI, Foshan (CN); Junqiang HE, Foshan (CN); Huasheng LAI, Foshan (CN)

(73) Assignee: Guangdong Link Plus Technology Group Co., Ltd, Foshan (CN)

(21) Appl. No.: 19/198,123

(22) Filed: May 5, 2025

(30) Foreign Application Priority Data
Mar. 14, 2025 (CN) 2025103038691

(51) Int. Cl. A47J 43/044; A47J 43/07; A47J 43/08

(52) U.S. Cl. CPC A47J 43/044; A47J 43/0727; A47J 43/082

(57) ABSTRACT

The present application relates to the technical field of food processors, and in particular, to a micro puree machine. A bowl piece is mounted on a fixed platform, the bowl piece is provided with an accommodating cavity for food, and the bowl piece is provided with an extrusion port communicated with the accommodating cavity. An extrusion element is movably arranged in the accommodating cavity, so as to force the food in the accommodating cavity to be extruded from the extrusion port. The bowl piece is provided with an air channel in communication with the accommodating cavity. Airflow enters the accommodating cavity through the air channel to push the extrusion element to move from a first position to a second position, so as to force the food in the accommodating cavity to be extruded from the extrusion port. A moving platform is movably arranged relative to the fixed platform.

### CROSS-REFERENCE TO RELATED APPLICATIONS

The application claims priority to Chinese patent application No. 2025103038691, filed on Mar. 14, 2025, the entire contents of which are incorporated herein by reference.

### TECHNICAL FIELD

The present invention relates to the technical field of food processors, and in particular, to a micro puree machine.

### BACKGROUND

In the prior art, for example, Chinese utility model patent CN222265103U discloses a micro puree machine and an extrusion assembly, and the extrusion assembly uses a plunger coupled to a main driven shaft to push a processed ingredient out of a nozzle coupled to a bowl. The plunger includes a sealing member around its perimeter to ensure maximum contact with the wall of the bowl, allowing maximum extrusion output.

In the prior art, there are two methods for combining the plunger and the driven shaft.

The first combination method is that the cutter and the plunger are mounted on the same bowl cover, the driven shaft is combined with the cutter in a normal state, and the driven shaft is combined with the plunger in an extrusion state. The problem existing in this structure is that the driven shaft cannot be combined with the plunger, which affects the operation of the whole machine, the plunger and the cutter need to be reset manually, and normal use is seriously affected.

The second combination method is that the cutter and the plunger are respectively arranged on a first cover and a second cover, and after the cutter completes the mixing of rotating and crushing, the bowl piece is disassembled and the bowl cover is replaced, so as to replace the cutter with the plunger. Although this method does not have the problem of combining of the driven shaft and the plunger, it requires manual disassembly of the bowl piece and replacement of the bowl cover. The process is too complicated, and is not practical, which needs to be further improved.

### SUMMARY

The present invention aims to solve one of technical problems existing in the prior art at least. Therefore, the present invention provides a micro puree machine.

A micro puree machine designed for this purpose, including a fixed platform;
a bowl piece, where the bowl piece is mounted on the fixed platform, the bowl piece is provided with an accommodating cavity for food, and the bowl piece is provided with an extrusion port communicated with the accommodating cavity; the bowl piece is provided with an air channel communicated with the accommodating cavity; and an air inlet end of the air channel is connected to an air source, the air source supplies air to the air channel, airflow enters the accommodating cavity to push the extrusion element to move from a first position to a second position, so as to force the food in the accommodating cavity to be extruded from the extrusion port;
an extrusion element, where the extrusion element is movably arranged in the accommodating cavity, so as to force the food in the accommodating cavity to be extruded from the extrusion port; and when the extrusion element is located at the first position, the extrusion element and the bowl piece are coupled to each other, so as to restrain the extrusion element and the bowl piece from rotating relatively;
a moving platform, where the moving platform is movably arranged relative to the fixed platform;
a cutter, where the cutter is rotatably connected to the moving platform, and the cutter extends into the accommodating cavity;
a moving module, where the moving module is configured to drive the moving platform to move linearly relative to the fixed platform; and
a driving module, where the driving module is arranged on the moving platform and is in transmission connection with the moving module and the cutter.

Preferably, the moving module includes a lead screw rotatably arranged on the fixed platform, the moving platform is rotatably provided with a lead screw nut, and the lead screw nut is in threaded connection with the lead screw;
the driving module is in transmission connection with the lead screw nut; and
the fixed platform is provided with a brake module, and the brake module is configured to apply a rotational resistance to the lead screw, so as to restrain the lead screw from rotating relative to the fixed platform.

Compared with the prior art, the adopted pneumatic driving extrusion element in the present invention not only does not need to consider the problem that the cutter shaft is combined with the extrusion element, but also does not need to disassemble the bowl piece in the food preparation process. The normal operation of the machine can be ensured while effectively reducing manual operation, so that the smoothness of manufacturing is improved, and the requirements of users are met.

Compared with the prior art, according to the brake module provided by the present invention, when the brake module does not generate resistance to the lead screw, the lead screw and the lead screw nut rotate synchronously, so as to enable the moving platform to be kept hovering at one position, and meanwhile, the cutter, the lead screw, and the lead screw nut rotate synchronously to achieve mixing of rotating and crushing. When the brake module generates resistance to the lead screw, the lead screw is restrained by the resistance, and the lead screw nut can move upwards and downwards relative to the lead screw along with rotation, so that the moving platform drives the cutter to move. In this solution, under the condition that the lead screw nut is kept at the same rotating speed, the larger the resistance constraint of the lead screw is, the faster the movement speed of the lead screw nut relative to the lead screw is, so as to change the displacement speed of the cutter.

Compared with the prior art, since the lead screw is arranged in a rotating manner, and under the cooperation of the brake module, the micro puree machine has the advantages of preventing the motor from being overloaded and blocked. Since the motor needs to synchronously drive the cutter to rotate and move during operation, when the cutter is blocked and unable to move, that is, when the moving resistance of the cutter is greater than the resistance applied by the brake module, the lead screw nut and the lead screw rotate synchronously, and the moving platform does not move relative to the fixed platform, thus achieving a state in which the cutter only rotates but does not move, so as to ensure the normal operation of the motor and avoid damage to the motor as well as the transmission structure.

### BRIEF DESCRIPTION OF THE DRAWINGS

FIG. 1 is a schematic diagram of a three-dimensional structure of a micro puree machine;

FIG. 2 is a schematic diagram 1 of a cross-sectional structure of a micro puree machine;

FIG. 3 is a schematic diagram 2 of a cross-sectional structure of a micro puree machine;

FIG. 4 is a schematic diagram of a cross-sectional structure of a micro puree machine in a use state;

FIG. 5 is a schematic structural diagram of a bowl piece, an extrusion element, and a cutter;

FIG. 6 is a schematic diagram of a position of an extrusion element in a first position;

FIG. 7 is a schematic diagram of a position of an extrusion element in a second position;

FIG. 8 is a schematic diagram 1 of a three-dimensional structure of a bowl piece and a bowl cover;

FIG. 9 is a schematic diagram 2 of a three-dimensional structure of a bowl piece and a bowl cover;

FIG. 10 is a schematic diagram of a cross-sectional structure of a bowl piece and a bowl cover;

FIG. 11 is a schematic diagram of a decomposition structure of a bowl piece and a bowl cover;

FIG. 12 is a schematic diagram 1 of a three-dimensional structure of an extrusion element;

FIG. 13 is a schematic diagram 2 of a three-dimensional structure of an extrusion element;

FIG. 14 is a schematic diagram 1 of a three-dimensional structure of a cutter;

FIG. 15 is a schematic diagram 2 of a three-dimensional structure of a cutter;

FIG. 16 is a schematic diagram of a first implementation of a brake module;

FIG. 17 is a schematic diagram of a second implementation of a brake module; and

FIG. 18 is a schematic diagram of a third implementation of a brake module.

### DETAILED DESCRIPTION OF THE EMBODIMENTS

The following describes implementations of the technical solutions of the present application in detail with reference to the accompanying drawings. The following implementations are merely used for illustrating the technical solutions of the present application more clearly, and therefore, are merely examples and cannot limit the scope of protection of the present application.

Unless otherwise defined, all technical and scientific terms used herein have the same meanings as those commonly understood by those of ordinary skill in the art to which the present application belongs. The terms used in the specification of the present application are merely for the purpose of describing specific implementations, but are not intended to limit the present application. The terms “include”, “have”, and any other variant thereof in the specification, claims, and drawings of the present application, are intended to cover a non-exclusive inclusion.

In the description of the implementations of the present application, the technical terms “first”, “second”, etc. are merely used for distinguishing different objects and should not be construed as indicating or implying their relative importance or implying the number, specific order, or primary and secondary relationships of technical features indicated.

The reference to “implementation” herein means that a particular feature, structure, or characteristic described with reference to the implementations may be included in at least one implementation of the present application. The appearances of the phrases in various place in the specification may not refer to a same implementation, or an independent or a candidate implementation that is mutually exclusive of other implementations. Those skilled in the art explicitly and implicitly understand that the implementations described herein may be combined with other implementations.

In the description of implementations of the present application, the term “and/or” describes only an association relationship for describing associated objects and represents that three relationships may exist. For example, A and/or B may represent the following three cases: Only A exists, both A and B exist, and only B exists. In addition, a character “/” in this specification generally indicates an “or” relationship between contextually associated objects.

In the description of the implementations of the present application, the terms “a plurality of” means two (inclusive) or more. Similarly, “a plurality of groups” means two (inclusive) or more groups, and “a plurality of pieces” means two (inclusive) or more pieces.

In the description of the implementations of the present application, an orientation or positional relationship indicated by the technical terms “center”, “longitudinal”, “transverse”, “length”, “width”, “thickness”, “upper”, “lower”, “front”, “back”, “left”, “right”, “vertical”, “horizontal”, “top”, “bottom”, “internal”, “external”, “clockwise”, “counterclockwise”, “axial direction”, “radial direction”, “circumferential direction”, or the like is based on an orientation or positional relationship shown in the accompanying drawings, and is merely for ease of describing the implementations of the present application and simplifying the description, but does not indicate or imply that an apparatus or an element referred to must have a specific orientation or be constructed and operated in a specific orientation, and therefore cannot be understood as a limitation on the implementations of the present application.

In the description of the implementations of the present application, unless otherwise expressly specified and defined, the technical terms “mounted”, “attached”, “connected”, “fixed”, etc. should be understood in a broad sense, for example, a connection may be a fixed connection, a detachable connection, or an integral connection; it may be a mechanical connection or an electrical connection; it may be a direct connection or an indirect connection via an intermediate medium; and it may be a connection between two elements or an interaction between two elements. For those of ordinary skill in the art, the specific meaning of the foregoing terms in the implementations of the present application may be understood based on specific situations.

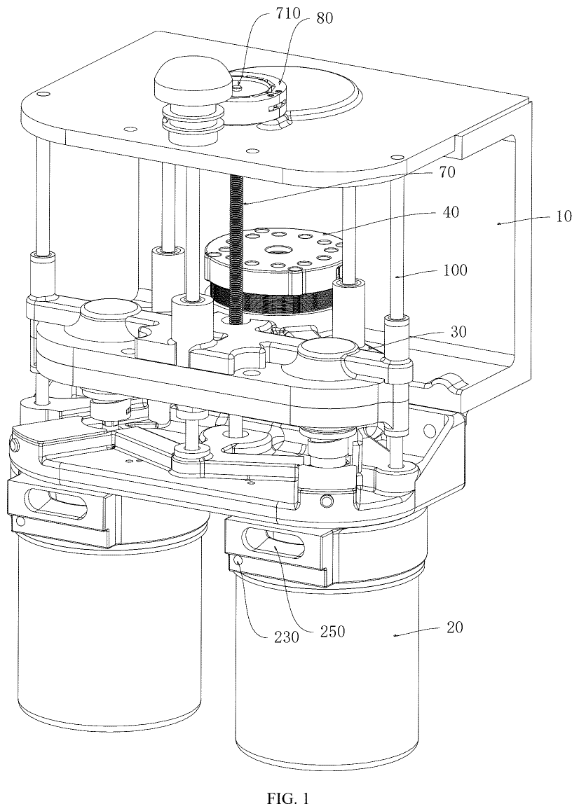

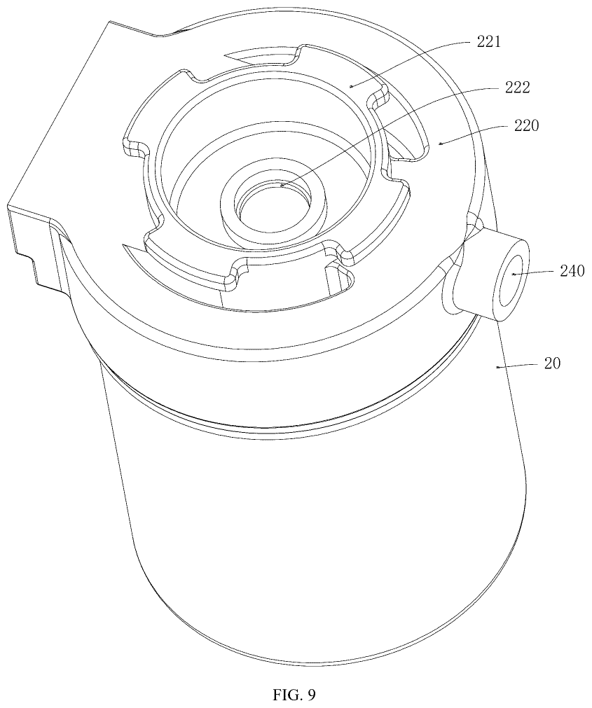

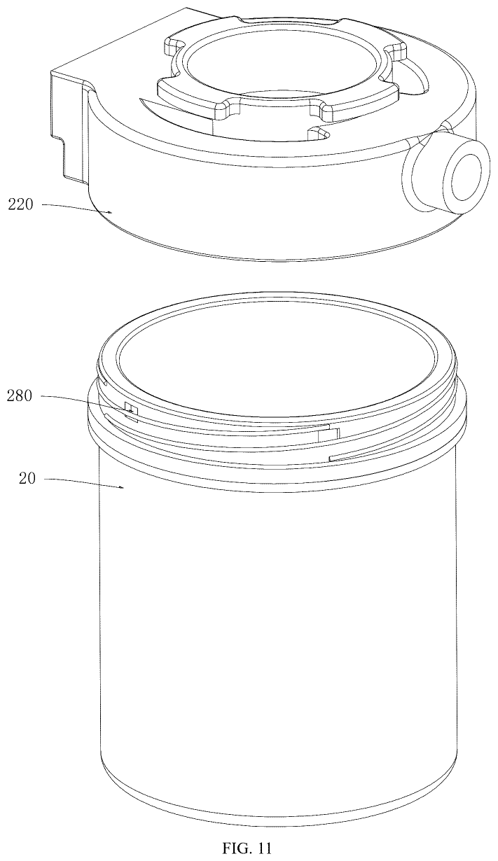

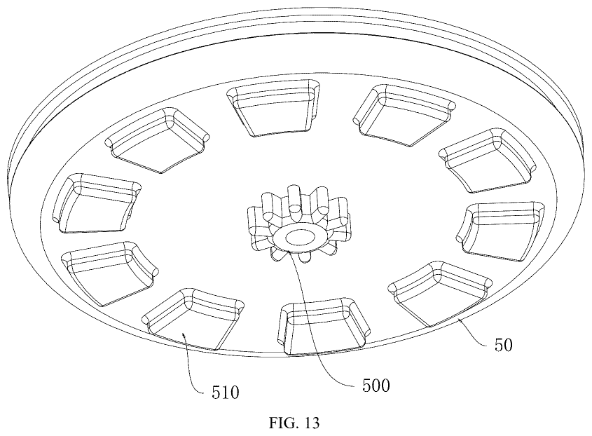

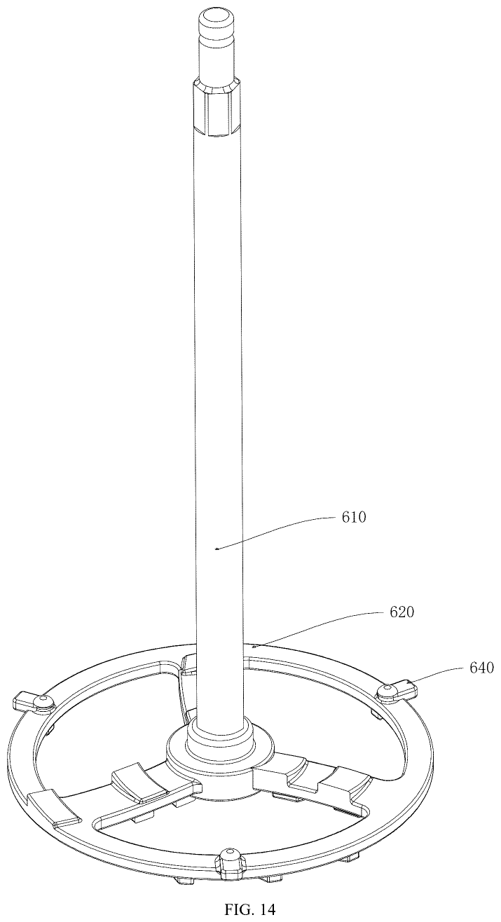

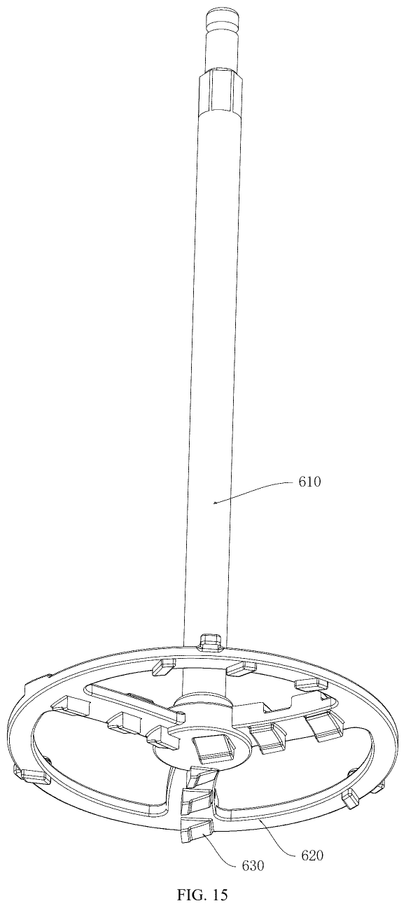

As shown in the FIG. 1 to FIG. 18, a micro puree machine includes a fixed platform 10; a bowl piece 20, where the bowl piece 20 is mounted on the fixed platform 10, the bowl piece 20 is provided with an accommodating cavity 201 for food, and the bowl piece 20 is provided with an extrusion port 240 communicated with the accommodating cavity 201; the bowl piece 20 is provided with an air channel 210 communicated with the accommodating cavity 201; and an air inlet end of the air channel 210 is connected to an air source, the air source supplies air to the air channel 210, airflow enters the accommodating cavity 201 to push the extrusion element 50 to move from a first position 202 to a second position 203, so as to force the food in the accommodating cavity 201 to be extruded from the extrusion port 240; an extrusion element 50, where the extrusion element 50 is movably arranged in the accommodating cavity 201, so as to force the food in the accommodating cavity 201 to be extruded from the extrusion port 240; and when the extrusion element 50 is located at the first position, the extrusion element 50 and the bowl piece 20 are coupled to each other, so as to restrain the extrusion element and the bowl piece from rotating relatively; a moving platform 30, where the moving platform 30 is movably arranged relative to the fixed platform 10; a cutter 60, where the cutter 60 is rotatably connected to the moving platform 30, and the cutter 60 extends into the accommodating cavity 201; a moving module 70, where the moving module 70 is configured to drive the moving platform 30 to move linearly relative to the fixed platform 10; and a driving module 40, where the driving module 40 is arranged on the moving platform 30 and is in transmission connection with the moving module 70 and the cutter 60.

During using, the user mounts the bowl piece 20 containing the food to the fixed platform 10. When the micro puree machine is in an operation mode, a rotating and crushing mode and an extrusion mode can be executed.

In the rotating and crushing mode, under the action of the driving module, the cutter 60 and the moving module 70 are synchronously driven, and under the action of the moving module 70, the moving platform 30 is driven to move linearly relative to the fixed platform 10, a moving direction of the moving platform is to move from the second position 203 to the first position 202, then reset is performed to move from the first position 202 to the second position 203, and meanwhile, the cutter 60 is driven to rotate. In this mode, the cutter 60 can rotate and synchronously move, so as to rotate and crush food in the bowl piece 20.

In the extrusion mode, under the action of the air source, the airflow drives the extrusion element 50 to move from the first position 202 to the second position 203, so as to force the food in the accommodating cavity 201 to be extruded from the extrusion port 240.

During using, the airflow drives the extrusion element 50 to move from the first position 202 to the second position 203 to complete the extrusion of the food. With regard to the reset problem of the extrusion element 50, the extrusion element 50 is manually reset, that is, after food extrusion is completed, the bowl piece 20 is removed from the fixed platform 10, and after the bowl piece 20 and the extrusion element 50 are cleaned, the extrusion element 50 is mounted to the accommodating cavity 201 and is driven to move to the first position 202, thereby completing resetting.

In the rotating and crushing mode, when the cutter 60 moves to the second position 203, the cutter 60 presses against a surface of the extrusion element 50 along with movement, this step is to avoid the situation that when the whole bowl piece 20 is frozen along with the food, the extrusion element 50 is frozen and cannot be loosened. The cutter 60 presses the extrusion element 50 for the purpose of generating a slight displacement of the extrusion element 50 relative to the bowl piece 20 to break frost between the extrusion element 50 and the bowl piece 20, so as to ensure that the extrusion element 50 can move relative to the bowl piece 20, thereby enabling the food to be extruded from the extrusion port 240.

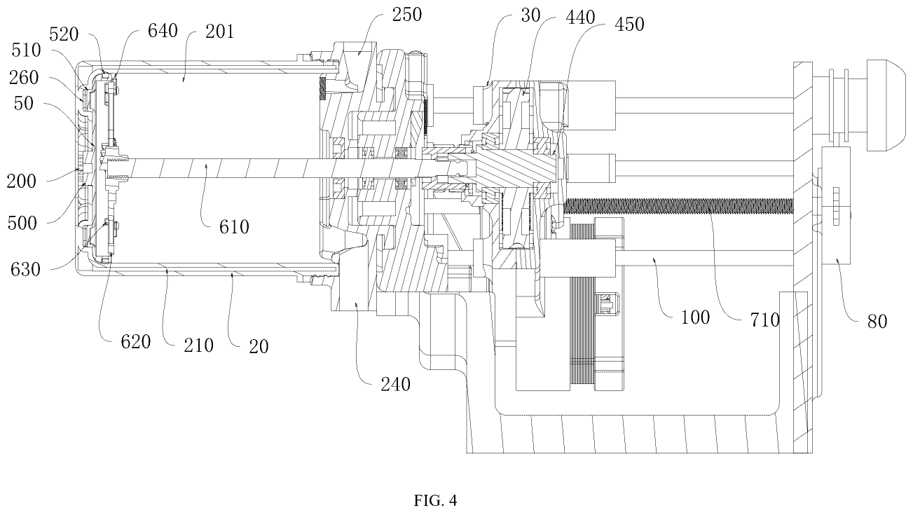

As shown in FIG. 4, in this figure, the micro puree machine is in a use state, the extrusion port 240 is arranged downwards, so that after the extrusion element forces the food in the accommodating cavity 201 to be extruded from the extrusion port 240, the food is extruded downwards, so as to facilitate the collection of the user under the extrusion port 240.

As shown in FIG. 1, the fixed platform 10 is provided with a plurality of guide columns 100, the moving platform 30 is slidably connected to the guide columns 100, so as to ensure the stability of the movement of the moving platform 30 relative to the fixed platform 10.

The accommodating cavity 201 is a cavity of a columnar structure, the extrusion element 50 is of a disc structure, and the accommodating cavity and the extrusion element are matched with each other to enable the extrusion element 50 to move in the accommodating cavity 201.

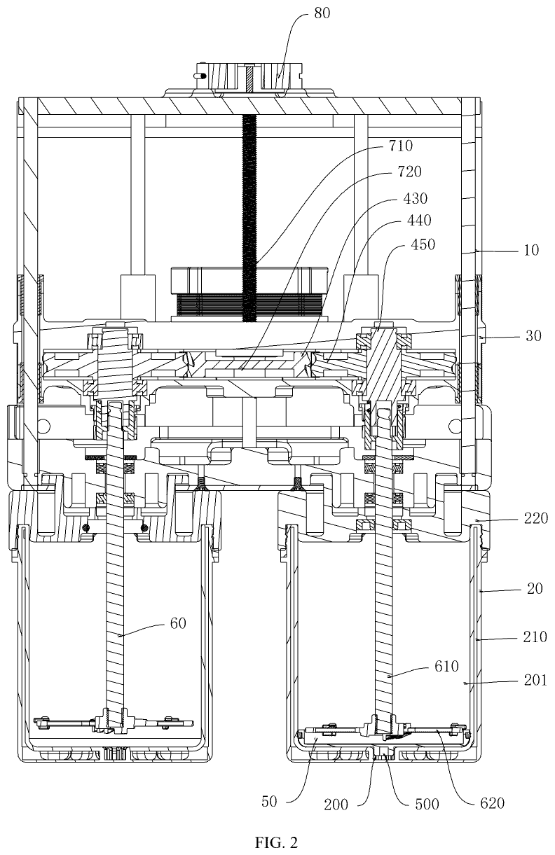

As shown in FIG. 2 to FIG. 4, the moving module 70 includes a lead screw 710 slidably connected to the fixed platform 10, the moving platform 30 is rotatably provided with a lead screw nut 720, and the lead screw nut 720 is in threaded connection with the lead screw 710; the driving module 40 is in transmission connection with the lead screw nut 720; and the fixed platform 10 is provided with a brake module 80, and the brake module 80 is configured to apply a rotational resistance to the lead screw 710, so as to restrain the lead screw 710 from rotating relative to the fixed platform 10. In this embodiment, the lead screw 710 is different from a lead screw in the existing lead screw linear transmission, and the lead screw 710 is rotatably arranged. When the brake module does not generate resistance to the lead screw, the lead screw and the lead screw nut rotate synchronously, so as to enable the moving platform to be kept hovering at any position, and meanwhile, when the cutter rotates, the cutter can hover at any position for rotating and crushing. However, when the brake module generates resistance to the lead screw, the lead screw is restrained by the resistance, and the lead screw nut can move upwards and downwards relative to the lead screw along with rotation, so that the moving platform drives the cutter to move. In this solution, under the condition that the lead screw nut is kept at the same rotating speed, the larger the resistance constraint of the lead screw is, the faster the movement speed of the lead screw nut relative to the lead screw is, so as to change the displacement speed of the cutter. Therefore, under the action of the brake module 80, the micro puree machine, under the action of the driving module, can control whether the cutter 60 moves or not and the movement speed of the cutter to be fast and slow while the cutter 60 rotates all the time, so as to adjust the movement of the cutter 60 according to a specific food, thereby preparing the food with better taste, and meeting the requirements of users.

As shown in FIG. 2 to FIG. 4, the driving module 40 includes a driving motor 410 arranged on the moving platform 30, a motor shaft of the driving motor 410 is connected to a first gear 420, the lead screw nut 720 is connected to a second gear 430, the second gear 430 is in transmission connection with the cutter 60, and the first gear 420 and the second gear 430 are engaged with each other.

The lead screw nut 720 and the second gear 430 are of an integrated structure.

As shown in FIG. 2, the cutter 60 includes a cutter shaft 610, one end of the cutter shaft 610 is rotatably connected to the moving platform 30, the other end of the cutter shaft is provided with a cutter head 620, and the cutter head 620 is provided with a first cutter tooth 630 for rotating and crushing the food; and the driving module 40 is rotatably connected to the cutter shaft 610. In the rotating process of the cutter head 620, the first cutter tooth 630 is in contact with the food in the accommodating cavity 201, so as to achieve mixing of rotating and crushing, and along with the displacement of the moving platform 30, the cutter head 620 is driven to move, so that the position is changed to achieve mixing of rotating and crushing at different positions.

As shown in FIG. 2 to FIG. 4, the moving platform 30 is rotatably provided with a coupling 450, the cutter shaft 610 is connected to the coupling 450, the coupling 450 is provided with a third gear 440, and the third gear 440 and the second gear 430 are engaged with each other.

The cutter shaft 610 is connected to the coupling 450, and the cutter and the coupling can be connected by using an existing connecting structure, for example, an existing connecting structure such as a rotary buckle connection or a threaded connection.

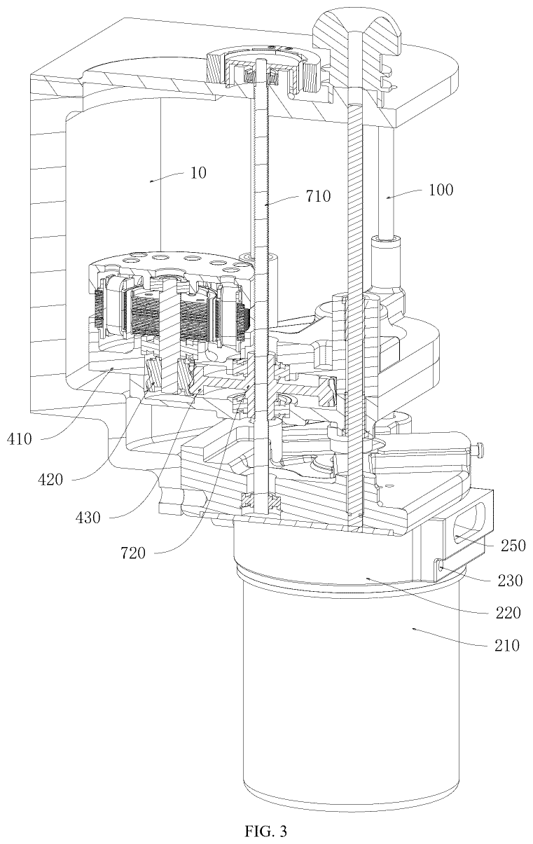

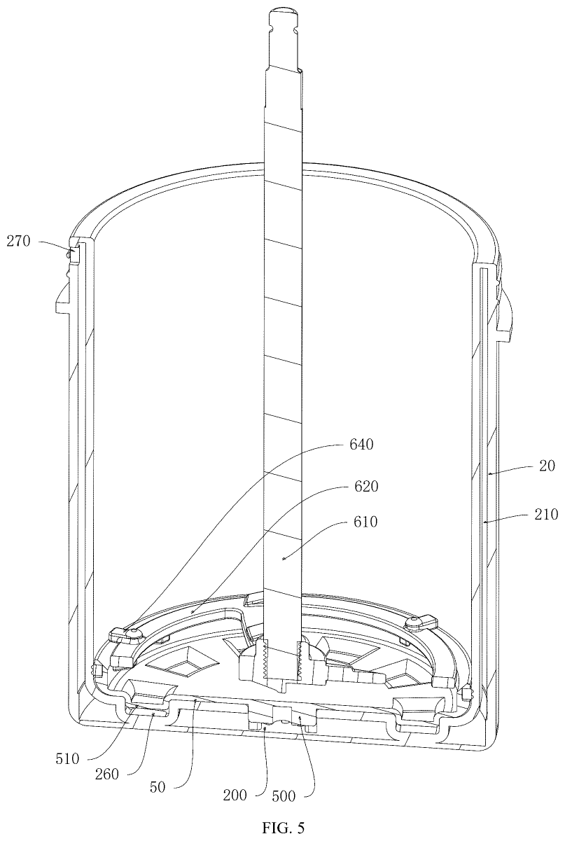

As shown in FIG. 3 and FIG. 5, a circumferential wall of the cutter head 620 is provided with a second cutter tooth 640, and the second cutter tooth 640 extends along a radial direction of the cutter head 620; and the first cutter tooth 630 extends along an axial direction of the cutter shaft 610. The second cutter tooth 640 is used for cleaning food adhered to the circumferential wall of the accommodating cavity 201, so that the food is prevented from being frozen on the circumferential wall of the accommodating cavity 201 to influence the movement of the extrusion element 50. In the process of moving and rotating and crushing of the cutter head 620, the second cutter tooth 640 extending along the radial direction of the cutter head 620 can crush the food on the circumferential wall of the accommodating cavity 201, so as to ensure that the extrusion element 50 can be attached to the circumferential wall of the accommodating cavity 201 to move.

The plurality of second cutter teeth are arranged on the cutter head in a circumferential arrangement.

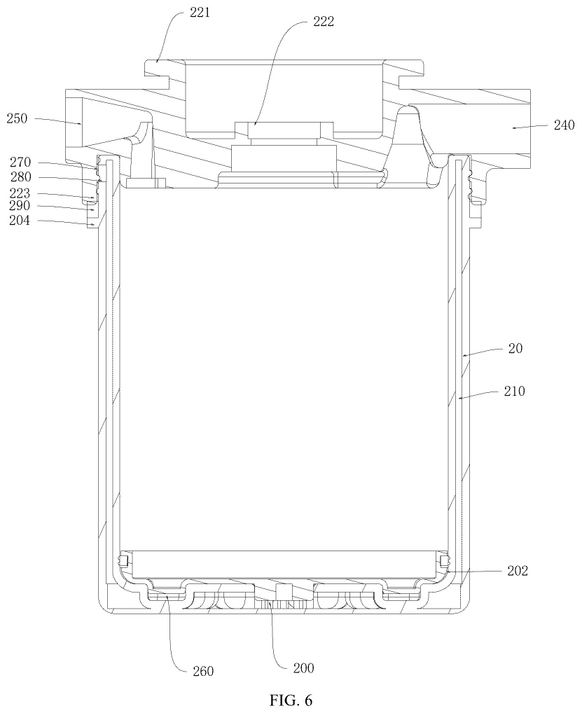

As shown in FIG. 3 and FIG. 6, the bowl piece 20 is connected to a bowl cover 220, and the extrusion port 240 is arranged on the bowl cover 220.

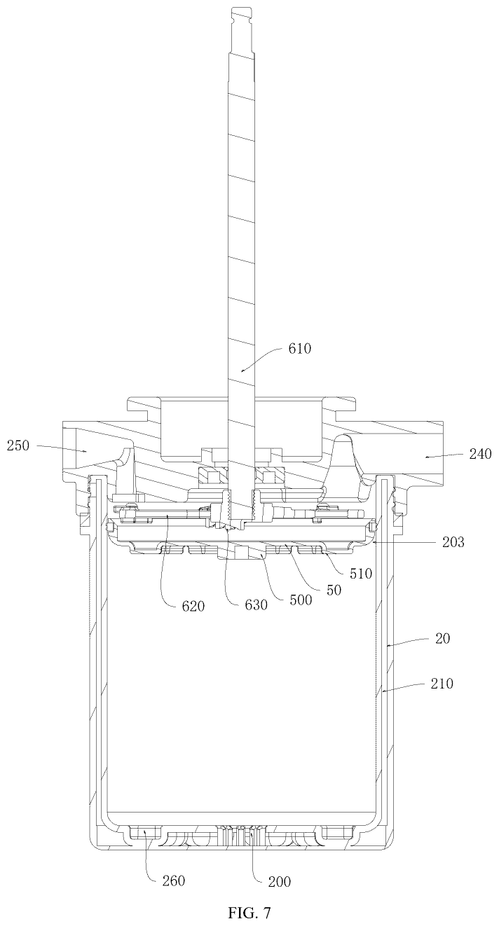

As shown in FIG. 6 and FIG. 7, an upper side of the bowl piece 20 is provided with an opening, and the bowl cover 220 is arranged on the upper side of the bowl piece 20. Under the action of the airflow, the extrusion element 50 moves from the first position 202 to the second position 203, that is, moves from bottom to top, so as to drive the food to move from bottom to top until the food is extruded from the extrusion port 240.

As shown in FIG. 3 and FIG. 6, the bowl cover 220 is mounted on the fixed platform 10, the bowl piece 20 is detachably connected to the bowl cover 220, and the bowl piece and the bowl cover can be connected through a threaded structure or a rotary buckle structure.

The bowl cover 220 is provided with a shaft hole 222, the cutter shaft 610 penetrates through the shaft hole 222 and extends into the accommodating cavity 201 inside the bowl piece 20, and the cutter shaft 610 can be movably arranged relative to the shaft hole 222.

The bowl cover 220 is provided with a rotary buckle structure 221, and the rotary buckle structure 221 is in rotary buckle connection with the fixed platform 10.

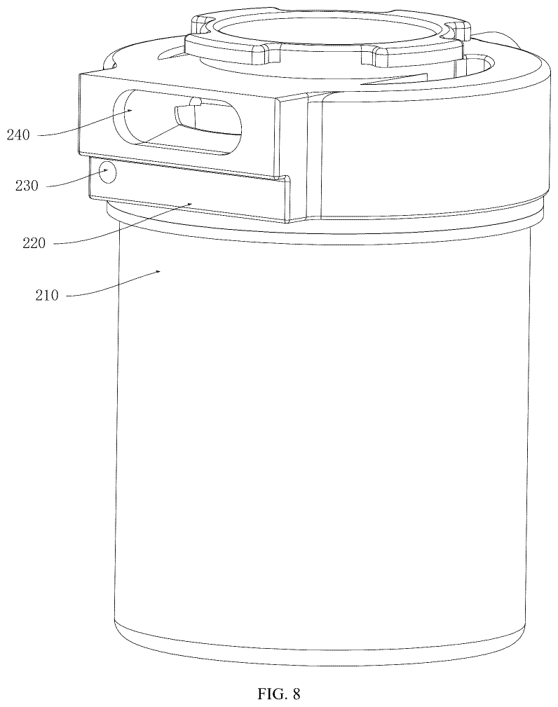

As shown in FIG. 8, the bowl cover 220 is provided with an air inlet hole 230, and the air inlet hole 230 is in communication with the air channel 210. The advantage of arranging the air inlet hole 230 in the bowl cover 220 is that since the air source needs to be arranged on the fixed platform 10, when the bowl piece 20 is disassembled each time, the connection of the air source does not affect the disassembly of the bowl piece 20, which is convenient to operate.

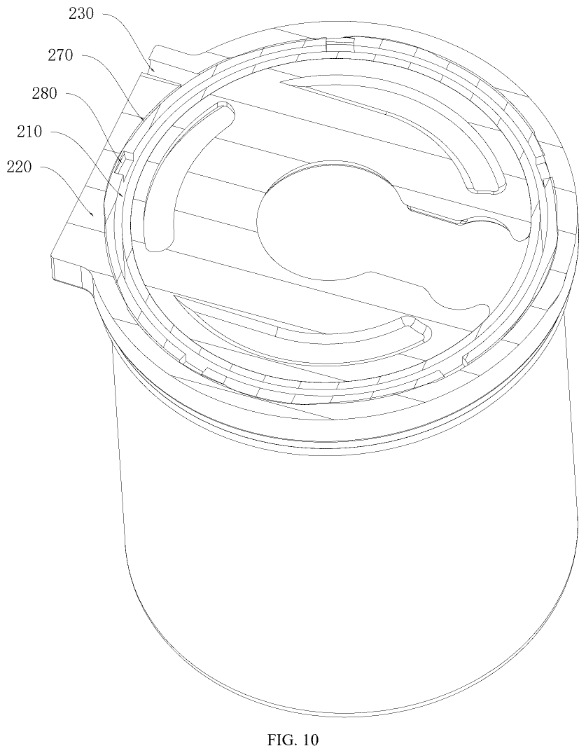

As shown in FIG. 7 and FIG. 10, the bowl piece 20 is provided with an air inlet 280, and a communicating air cavity 270 is arranged between the bowl cover 220 and the bowl piece 20; and the air inlet hole 230, the communicating air cavity 270, the air inlet 280, and the air channel 210 are sequentially communicated.

As shown in FIG. 6, an outer wall of the bowl piece 20 is provided with a lug boss 204, a sealing rubber ring 290 is arranged on the lug boss 204, and when the bowl cover 220 is connected to the bowl piece 20, a convex ring 223 of the bowl cover 220 abuts against the sealing rubber ring 290, and the bowl cover 220, the sealing rubber ring 290, and the bowl piece 20 are enclosed to form a communicating air cavity 270. That is, when the bowl cover 220 is connected to the bowl piece 20, the communicating air cavity 270 is automatically formed.

When the extrusion element 50 is assembled to the first position 202, an air gap is formed between the extrusion element 50 and a bottom wall of the accommodating cavity 201, the airflow enters the interior of the air gap through the air channel 210, and the airflow in the air gap pushes the whole extrusion element 50 to move relative to the bowl piece 20. The air gap allows the entering airflow to be evenly distributed, so as to ensure the stability of pushing the extrusion element.

The fixed platform 10 is provided with an air source, and the air source is connected to the air inlet hole 230 through a pipe fitting. The air source is an air pump, and the specification of the air pump is selected according to the required thrust, so that the air flow pushes the extrusion element 50 to move. The air pump outputs airflow, and the airflow is sequentially communicated through the pipe fitting, the air inlet hole 230, the communicating air cavity 270, the air inlet 280 and the air channel 210.

Referring to FIG. 6, the bowl cover 220 is provided with a material port 250 communicated with the accommodating cavity 201. The effect of the material port 250 is that after the food is rotated and crushed, the material port 250 can add a fluid material into the accommodating cavity 201 under the action of a material pump, so that the newly added material is mixed and prepared with the rotated and crushed food.

The material port 250 and the extrusion port 240 are respectively provided with a valve body. The valve body is a one-way valve body, and when the valve body is applied to the material port 250, one-way opening of the valve body can enable an external material to enter the accommodating cavity 201 through the material port 250. Meanwhile, when the valve body is applied to the extrusion port 240, one-way opening of the valve body can enable the food in the accommodating cavity 201 to be output to the outside through the extrusion port 240 under the action of the extrusion element.

As shown in FIG. 3 and FIG. 5, the extrusion element 50 is provided with a first coupling portion 510, and a bottom wall of the accommodating cavity 201 is provided with a second coupling portion 260; and the first coupling portion 510 and the second coupling portion 260 are inserted into and matched with each other, so as to restrain the extrusion element 50 and the bowl piece 20 from rotating relative to each other. When the food is manufactured, the extrusion element 50 needs to be mounted in the accommodating cavity 201 and attached to the bottom wall of the accommodating cavity 201, and the first coupling portion 510 and the second coupling portion 260 are inserted into and matched with each other, and after the matching is completed, the extrusion element 50 can be restrained with the bowl piece 20, and the extrusion element 50 is restrained, so that when the extrusion element is located at the first position 202, the extrusion element cannot rotate relative to the bowl piece 20. Therefore, when the cutter 60 rotates and crushes the food, the food frozen on the extrusion element 50 is prevented from rotating due to the rotation of the extrusion element 50. It is ensured that normal rotating and crushing of the cutter 60, and the situation that the food cannot be rotated and crushed due to the fact that the food rotates along with the cutter 60 is avoided.

As shown in FIG. 7, the bottom wall of the accommodating cavity 201 is provided with a communicated hole 200, and the communicated hole 200 is communicated with the accommodating cavity 201 and the air channel 210. The communicated hole 200 has a function of connection, allowing the airflow in the air channel 210 to enter the accommodating cavity 201 smoothly.

The communicated hole 200 is a non-circular hole, the extrusion element 50 is provided with a third coupling portion 500, a shape of the third coupling portion 500 is consistent with a shape of the communicated hole 200, and the third coupling portion 500 is movably inserted into the communicated hole 200. The arrangement of the non-circular hole is to restrain the extrusion element 50 from rotating relative to the bowl piece 20 after the third coupling portion 500 is inserted into and matched with the communicated hole 200.

The extrusion element 50 is attached to a circumferential wall of the accommodating cavity 201, and the arrangement of attaching is to ensure the sealing performance, so that airflow input from the air channel acts on the extrusion element 50 to push the extrusion element 50 to move.

As shown in FIG. 2 and FIG. 3, a sealing ring 520 is arranged on a wall surface, attached to the circumferential wall of the accommodating cavity 201, of the extrusion element 50, and the sealing ring 520 is attached to the circumferential wall of the accommodating cavity 201. The function of the sealing ring 520 is to enhance the sealing performance between the extrusion element 50 and the circumferential wall of the accommodating cavity 201, so as to prevent air leakage from affecting the thrust of the airflow pushing the extrusion element 50.

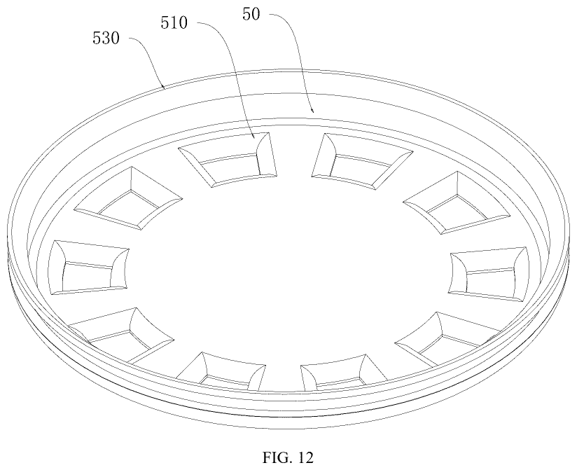

As shown in FIG. 12, the extrusion element 50 is provided with an annular cutter 530, the annular cutter 530 is attached to the circumferential wall of the accommodating cavity 201, and the annular cutter 530 extends from the first position 202 to the second position 203. The function of the annular cutter 530 is to clean food on the circumferential wall of the accommodating cavity 201, especially some smoothie particles remaining on the circumferential wall, so as to avoid affecting the movement of the extrusion element 50.

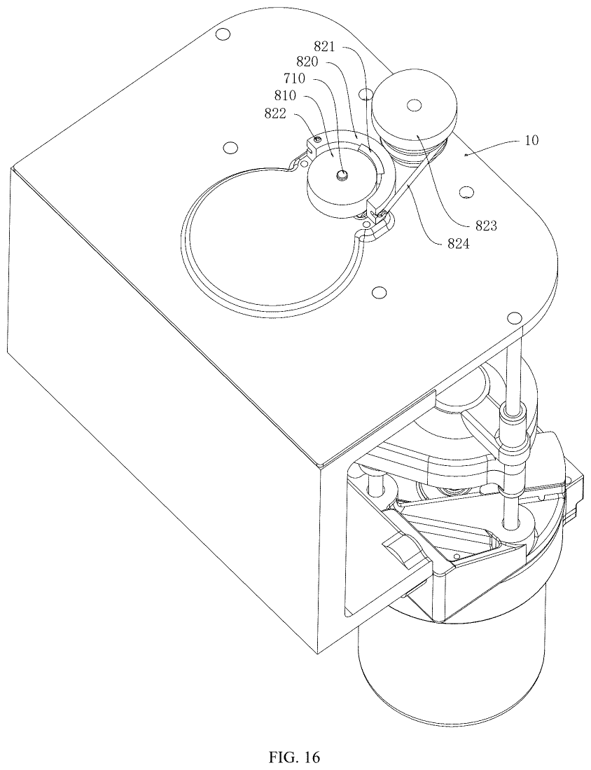

As shown in FIG. 16, a first implementation of the brake module 80 includes a brake rotor 810 fixedly arranged on a lead screw 710, and the fixed platform 10 is movably provided with a friction element 820; and when the friction element 820 is in contact with the brake rotor 810, the rotational resistance to the lead screw 710 is increased by generating the friction force, so as to restrain the lead screw 710 from rotating relative to the fixed platform 10. In this embodiment, the effect achieved is that under the action of contact friction, the rotational resistance to the lead screw 710 is improved, the larger the friction force is, the larger the rotational resistance borne by the lead screw is, and when the driving motor 410 is kept at the same rotating speed, the linear movement speed of the lead screw nut 720 relative to the lead screw 710 is faster. On the contrary, when the friction force is smaller, the rotational resistance borne by the lead screw 710 is smaller, and the linear movement speed of the lead screw nut 720 relative to the lead screw 710 is slower.

As shown in FIG. 16, the friction element 820 is of a semicircular structure, one end of the friction element 820 is rotatably arranged on the fixed platform 10, the other end of the friction element 820 is rotatably connected to a first pull rod 824, the fixed platform 10 is rotatably provided with a first speed regulation knob 823, and the first pull rod 824 is rotatably connected to the first speed regulation knob 823. Under the action of the rotation of the first speed regulation knob 823, the first pull rod 824 drives the friction element 820 to rotate around a first main shaft 822, so that the friction element 820 is gradually close to the brake rotor 810 or gradually away from the brake rotor 810 along with forward rotation or reverse rotation of the first speed regulation knob 823.

The first speed regulation knob 823 can be rotatably arranged on the fixed platform 10 by adopting a rotary damper. Therefore, the first speed regulation knob 823 is prevented from rotating under the action of other external force to cause the friction coefficient of the friction element 820 and the brake rotor 810 to be changed to influence the movement speed of the lead screw nut 720.

As shown in FIG. 16, a friction plate 821 is arranged on a wall surface, facing the brake rotor 810, of the friction element 820. The arrangement of the friction plate 821 can improve wear resistance, so that the friction element is not prone to being damaged during long-term contact friction.

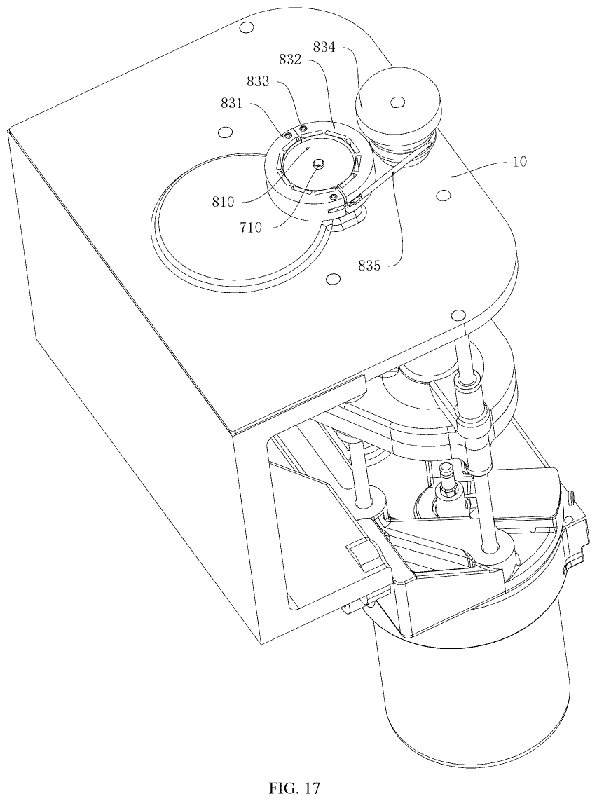

As shown in FIG. 17, in a second implementation of the brake module 80, the brake module 80 includes a brake rotor 810, a fixed magnetic ring frame 831, and a moving magnetic ring frame 832, and the fixed magnetic ring frame 831 and the moving magnetic ring frame 832 are provided with a permanent magnet each; the fixed magnetic ring frame 831 and the moving magnetic ring frame 832 are combined to form a magnetic ring, and the brake rotor 810 is arranged in the magnetic ring and is fixedly connected to the lead screw 710; the fixed magnetic ring frame 831 is fixedly arranged on the fixed platform 10, and the moving magnetic ring frame 832 is movably arranged relative to the fixed platform 10; and when the moving magnetic ring frame 832 is close to or away from the brake rotor 810, the magnetic field strength is changed to change the rotational resistance of the lead screw 710. As the moving magnetic ring frame 832 moves relative to the fixed platform 10, when the moving magnetic ring frame is gradually away from the brake rotor 810, the magnetic field strength is gradually weakened, and the rotational resistance to the lead screw 710 is gradually reduced, thereby reducing the movement speed of the lead screw nut 720. On the contrary, when the moving magnetic ring frame 832 is gradually close to the brake rotor 810, the magnetic field strength is gradually enhanced, and the rotational resistance to the lead screw 710 is gradually increased, thereby increasing the movement speed of the lead screw nut 720.

As shown in FIG. 17, one end of the moving magnetic ring frame 832 is rotatably connected to the fixed platform 10, the other end of the moving magnetic ring frame 832 is provided with a second pull rod 835, the fixed platform 10 is rotatably provided with a second speed regulation knob 834, and the second pull rod 835 is rotatably connected to the second speed regulation knob 834. Under the action of the rotation of the second speed regulation knob 834, the second pull rod 835 drives the moving magnetic ring frame 832 to rotate around a second main shaft 833, so that the moving magnetic ring frame 832 is gradually close to the brake rotor 810 or gradually away from the brake rotor 810 along with forward rotation or reverse rotation of the second speed regulation knob 834.

The second speed regulation knob 834 can be rotatably arranged on the fixed platform 10 by adopting a rotary damper. Therefore, the second speed regulation knob 834 is prevented from rotating under the action of other external force to cause the distance between the moving magnetic ring frame 832 and the brake rotor 810 to be changed to influence the movement speed of the lead screw nut 720.

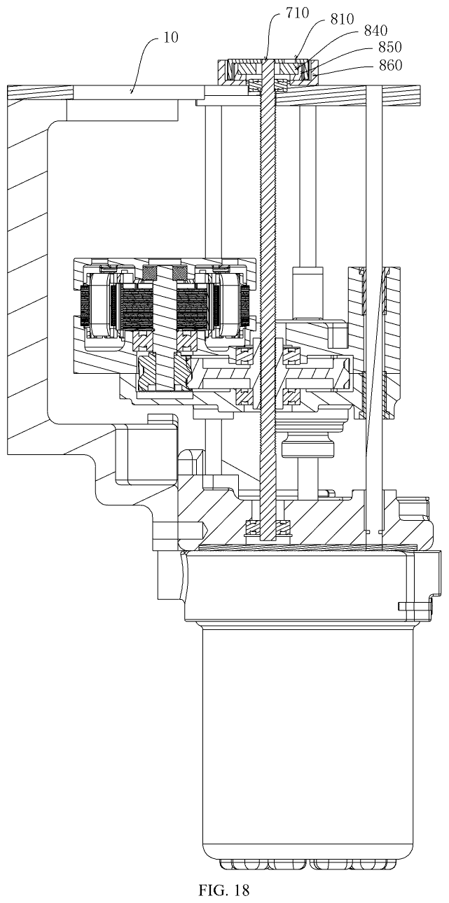

As shown in FIG. 18, in a third implementation of the brake module 80, the brake module 80 includes a stator magnetic pole 860, the stator magnetic pole 860 is connected to a fixed ring 850, a coil 840 is arranged in the fixed ring 850, a brake rotor 810 is arranged between the fixed ring 850 and the stator magnetic pole 860, and the brake rotor 810 is fixedly connected to the lead screw 710. In this embodiment, the principle of the brake module 80 is the same as that of an existing hysteresis brake. The brake module is powered on through the coil 840 to change an excitation current of the coil 840, thereby adjusting the intensity of the magnetic field to control the magnitude of the torque of the brake rotor 810, so as to change the rotational resistance of the lead screw 710, thereby restraining the lead screw 710 from rotating.

In the description of the present invention, it should be understood that the orientations or positional relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counter-clockwise”, etc. are in accordance with those shown in the accompanying drawings and intended only for the convenience of describing the present invention and simplifying the description rather than for indicating or implying that the referred equipment or element must be provided with a particular orientation or constructed and operated in a particular orientation; therefore, they should not be construed as limiting the present invention. The terms “first” and “second” are merely intended for a purpose of description and should not be construed as indicating or implying their relative importance or implying the quantity of technical features indicated.

The above shows and describes basic principles, main features, and advantages of the present invention. A person skilled in the art should understand that the present invention is not limited to the above embodiments, the descriptions in the above embodiments and specification are merely to illustrate the principles of the present invention, and various changes and improvements may be made to the present invention without departing from the spirit and scope of the present invention. These changes and improvements shall fall within the scope of protection claimed in the present invention. The scope of protection claimed in the present invention is defined by the appended claims and equivalents thereof.

What is claimed is:

1. A micro puree machine, comprising a fixed platform (10);
a bowl piece (20), wherein the bowl piece (20) is mounted on the fixed platform (10), the bowl piece (20) is provided with an accommodating cavity (201) for food, and the bowl piece (20) is provided with an extrusion port (240) communicated with the accommodating cavity (201); the bowl piece (20) is provided with an air channel (210) communicated with the accommodating cavity (201); and an air inlet end of the air channel (210) is connected to an air source, the air source supplies air to the air channel (210), airflow enters the accommodating cavity (201) to push the extrusion element (50) to move from a first position (202) to a second position (203), so as to force the food in the accommodating cavity (201) to be extruded from the extrusion port (240);
an extrusion element (50), wherein the extrusion element (50) is movably arranged in the accommodating cavity (201), so as to force the food in the accommodating cavity (201) to be extruded from the extrusion port (240); and when the extrusion element (50) is located at the first position, the extrusion element (50) and the bowl piece (20) are coupled to each other, so as to restrain the extrusion element and the bowl piece from rotating relatively;
a moving platform (30), wherein the moving platform (30) is movably arranged relative to the fixed platform (10);
a cutter (60), wherein the cutter (60) is rotatably connected to the moving platform (30), and the cutter (60) extends into the accommodating cavity (201);
a moving module (70), wherein the moving module (70) is configured to drive the moving platform (30) to move linearly relative to the fixed platform (10); and
a driving module (40), wherein the driving module (40) is arranged on the moving platform (30) and is in transmission connection with the moving module (70) and the cutter (60).

2. The micro puree machine according to claim 1, wherein the moving module (70) comprises a lead screw (710) rotatably arranged on the fixed platform (10), the moving platform (30) is rotatably provided with a lead screw nut (720), and the lead screw nut (720) is in threaded connection with the lead screw (710);
the driving module (40) is in transmission connection with the lead screw nut (720); and
the fixed platform (10) is provided with a brake module (80), and the brake module (80) is configured to apply a rotational resistance to the lead screw (710), so as to restrain the lead screw (710) from rotating relative to the fixed platform (10).

3. The micro puree machine according to claim 2, wherein the driving module (40) comprises a driving motor (410) arranged on the moving platform (30), a motor shaft of the driving motor (410) is connected to a first gear (420), the lead screw nut (720) is connected to a second gear (430), the second gear (430) is in transmission connection with the cutter (60), and the first gear (420) and the second gear (430) are engaged with each other.

4. The micro puree machine according to claim 1, wherein the cutter (60) includes a cutter shaft (610), one end of the cutter shaft (610) is rotatably connected the moving platform (30), the other end of the cutter shaft is provided with a cutter head (620), and the cutter head (620) is provided with a first cutter tooth (630) for rotating and crushing the food; and
the driving module (40) is rotatably connected to the cutter shaft (610).

5. The micro puree machine according to claim 4, wherein a circumferential wall of the cutter head (620) is provided with a second cutter tooth (640), and the second cutter tooth (640) extends along a radial direction of the cutter head (620); and
the first cutter tooth (630) extends along an axial direction of the cutter shaft (610).

6. The micro puree machine according to claim 1, wherein the bowl piece (20) is connected to a bowl cover (220), and the extrusion port (240) is arranged on the bowl cover (220).

7. The micro puree machine according to claim 6, wherein the bowl cover (220) is provided with an air inlet hole (230), and the air inlet hole (230) is communicated with the air channel (210).

8. The micro puree machine according to claim 7, wherein the bowl piece (20) is provided with an air inlet (280), and a communicating air cavity (270) is arranged between the bowl cover (220) and the bowl piece (20); and
the air inlet hole (230), the communicated air cavity (270), the air inlet (280), and the air channel (210) are sequentially communicated.

9. The micro puree machine according to claim 6, wherein the bowl cover (220) is provided with a material port (250) communicated with the accommodating cavity (201), and the material port (250) and the extrusion port (240) are respectively provided with a valve body.

10. The micro puree machine according to claim 1, wherein the extrusion element (50) is provided with a first coupling portion (510), and a bottom wall of the accommodating cavity (201) is provided with a second coupling portion (260); and the first coupling portion (510) and the second coupling portion (260) are inserted into and matched with each other, so as to restrain the extrusion element (50) and the bowl piece (20) from rotating relatively.
